(19) United States
(12) Patent Application Publication
(10) Pub. No.: US 2024/0324583 A1
(43) Pub. Date: Oct. 3, 2024

(54) METHOD AND KIT FOR CONTROLLING INVASIVE AND UNWANTED PLANTS

(71) Applicant: LA MACCHINA FTS AB, Vallda (SE)

(72) Inventors: Stefan BERGSTRÖM, Landvetter (SE); Kristian AKSELSEN, Särö (SE); Alexander ZIMMERMAN, Onsala (SE)

(21) Appl. No.: 18/579,168

(22) PCT Filed: Jul. 13, 2022
(86) PCT No.: PCT/SE2022/050709

§ 371 Date: Jan. 12, 2024

(30) Foreign Application Priority Data
Jul. 14, 2021 (SE) 2150941-9

(51) Int. Cl. A01M 21/04; A01G 11/00

(52) U.S. Cl. CPC A01M 21/04; A01G 11/00

(57) ABSTRACT

The present invention provides an environmentally friendly. safe and rapid method for controlling invasive plants and/or unwanted plants directly in a soil volume. the method comprising heating the entire soil volume to a temperature of at least 40° C. A kit comprising means for performing the method is also provided.

### TECHNICAL FIELD OF THE INVENTION

The present invention relates to an environmentally friendly, fast, and safe method for controlling invasive plants with an inaccessible root system in place (in situ) in the soil volume and a kit for carrying out the method.

### BACKGROUND OF THE INVENTION

There are many different invasive plants that are difficult and expensive to control or unwanted plants in general. Available control methods are divided into mechanical, chemical, and biological control.

Mechanical control means removing an invasive plant by cutting, mowing, digging, or pulling, but also covering the plant with the help of cover material, or spraying with warm water to kill sensitive parts of the plant (e.g., the root system). Control of plants mechanically is generally environmentally friendly but often requires greater work effort. For many invasive plants, it is enough that small living vegetative pieces remain in the soil to regain the plant. Other species can spread large numbers of seeds if the control is carried out at the wrong time of year Repeated cutting is labor intensive and takes a long time. It is also costly to deposit or burn infected soil. In addition, burned soil is almost never usable for vegetation and can therefore possibly be used as a filling material.

Hot water spraying only treats the upper parts of the soil volume and must therefore be repeated if deeper-lying roots are able to reach the surface again. Chemical control means using toxic substances for the plant that kill and prevent regrowth. Plant protection products such as herbicides (chemicals against weeds) are harmful to the environment and are subject to more and more restrictions, which makes them unusable in several contexts. The work effort is generally less compared to mechanical control, usually the treatment needs to be repeated several times to ensure eradication.

Biological control aims to permanently reduce a species dominance in nature with environmentally friendly methods. Unlike chemical control, you use natural processes performed by living organisms that are often specialized to live on the plant or animal you want to control. Against alien species, it may be necessary to import organisms from the plant's area of origin to find an effective biological pesticide but introducing new organisms for use in biological control may involve certain risks that need to be carefully evaluated and analyzed. Biological control can generally not kill stocks but only limit growth.

The most extreme example of problematic control is parkslide, which is an aggressive plant from Japan. Parkslide has a strong dispersal power with the ability to quickly take over large areas and displace other species. The root system can go several meters into the soil and survive for several years without access to photosynthesis and penetrate drainage and concrete via cracks.

Overall, there is a need for environmentally friendly, safe and fast methods and systems to effectively control invasive species and other unwanted plants on site (in situ).

### SUMMARY OF THE INVENTION

The present invention provides a method and kit for controlling invasive plants and their root systems as well as seeds in situ in a fast, safe, environmentally friendly and efficient manner. Other unwanted plants and their root systems can also be controlled with said method and kit.

The method which solves the above-mentioned problems comprises the steps defined in claim 1.

The method is used to control invasive plants or other unwanted plants in a soil volume, the method includes the steps of:
arranging one or more pipes in the soil volume to be treated,
providing a tempered fluid into at least one pipe (e.g., injection pipe) of the one or more pipes, the temperature of the tempered fluid is within the range of from 40° C. to 400° C.,
evacuating fluid from the soil volume via at least one pipe (e.g., evacuation pipe) of the one or more pipes,
measuring the temperature of the evacuated fluid, wherein the final temperature in the entire treated soil volume should exceed 40° C. to be effective, and
optionally covering the treatment area with an insulating cloth.

The largest energy carrier is preferably water vapor. The tempered fluid is provided into at least one pipe of the one or more pipes, (e.g., injection pipe(s)), to depress the fluid into the soil volume.

In a further embodiment, the fluid may be water vapor. In another embodiment, the fluid may be liquid mixed water vapor. In yet another embodiment, the fluid may be gas-mixed water vapor.

In yet another embodiment, the temperature of the evacuated fluid from the one or more evacuation pipes can be measured individually.

The final temperature in the entire treated soil volume should exceed 40° C. to be effective. Hence, the injected fluid must have a higher temperature than 40° C. In one embodiment, a temperature is in the range of from 40° C. to 400° C., preferably from 55° C. to 350° C., more preferably from 100° C. to 300° C. or even more preferably in the range of from 200° C. to 300° C. may be sufficient to effectively eradicate the unwanted plants.

The final temperature in the entire treated soil volume should exceed 40° C., preferably be at least 55° C.

The temperature of the evacuated fluid indicates the temperature in the treated soil volume. The temperature should exceed 40° C. Further, the temperature may be in the range of from 40 to 300° C., preferably in the range from 55 to 150° C. The temperature should be at least 55° C.

Depending on the plant and amount to be controlled, the temperature may need to be maintained over a period of from 30 minutes to 20 days. In a further embodiment, 1 hour to 10 days may be appropriate. In yet a further embodiment 1 hour to 1 day may be suitable, or preferably 1 to 5 hours should suffice, or even more preferably 30 minutes to 3 hours. If a temperature is maintained and exceeds 55° C., one hour may be sufficient treatment time. The time period for maintaining said temperatures depend on the plant, amount to be controlled and vegetative environment.

In yet another embodiment, the function of the one or more pipes can be switched between injection and evacuation of fluid while the soil volume is being treated, i.e., in real time. In one embodiment, the switching of function is performed by an operator.

In a further embodiment, the amount of injected fluid per respective pipe (i.e., per pipe) can be measured, and/or the pressure of injected fluid per respective pipe (injection pipe) can be measured.

In a further embodiment, the amount of evacuated fluid per respective pipe (evacuation pipe) can be measured, and/or the pressure of evacuated fluid per respective evacuation pipe can be measured.

In yet a further embodiment, measurement of the pressure and/or amount of the fluid can be measured in before and after injection and evacuation, respectively. The amount fluid and fluid pressure at each pipe are compared to find out if channels have formed in the soil volume.

In a further embodiment, sterilization of the soil surface can be performed before the method described and defined in claim 1 is started.

The method of treating an area described above can be performed manually or automatically or a mixture of manual and automated steps. One embodiment also includes a control system.

The method of treating an area described above may be a computer implemented method.

All embodiments described herein are compatible to combine with each other.

In addition to said method, there is also provided a Kit comprising means for controlling invasive plants and/or other unwanted plants in a soil volume by the method described according to claim 1.

### The Kit Includes:

one or more pipes,
one or more heating units,
one or more evacuation pumps,
one or more cloths,
one or more sensors,
one or more flow controllers, and
one or more coupling units, such as a hose.

The one or more pipes are suitable for injection and/or evacuation of fluid into/from the soil volume to be treated.

The heater is configured to heat said fluid to a certain temperature, which is preferably at least 100° C. The one or more sensors are provided to measure temperature, control temperature, measure pressure and/or flow, control pressure and/or flow.

The kit may (optionally) further comprise a data processing apparatus/device/system comprising means for carrying out the method described above and set out in claim 1.

The kit may also include instructions for use.

The system (means) may be controlled by a computer.

### BRIEF DESCRIPTION OF FIGURES

FIG. 1 Shows a cross section of an example of a soil volume to be treated with the present method

FIG. 2 Shows an example of an arrangement of the system (pipes) in area to be treated with the present method from above.

FIG. 3 Shows a cross section of a soil volume to be treated, illustrating a pipe with connected equipment for injection/evacuation.

### DETAILED DESCRIPTION OF THE INVENTION

Japanese knotweed (Parkslide) has a large underground network of roots (rhizomes). To eradicate the plant the roots need to be killed. All above-ground portions of the plant need to be controlled repeatedly for several years in order to weaken and kill the entire patch. The present disclosure provides an ecologically, environmentally friendly effective method and system for controlling vegetative invasive growth as defined in the claims. The method/system disclosed is a more effective alternative to chemical/biological/mechanical treatments presently known.

The advantage with the present method is that the treatment is performed in place (in situ) in which the invasive or unwanted plant or seed (infection) is located. By heating the entire volume of the infected soil as well as plant parts and seeds above ground to a temperature where everything dies, the control is complete in a single round of treatment. Moreover, the soil is still usable for cultivation and the soil has not been contaminated with toxic chemicals, which is a huge advantage over commonly known methods used today

Pipes are hollow elongated objects that usually have circular cross-sections and relatively thin wall. Pipes are often designed to conduct a fluid such as liquid or gas. However, the cross-section is not limiting in this case, shapes such as square, rectangular and cylindrical would also work but the circular shape of the pipe makes the pressure force evenly distributed, i.e., more suitable for the present disclosure.

Injection pipes are pipes into which a tempered fluid is introduced/injected which aim is to heat a soil volume. The direction of the fluid is from the ground surface downwards (longitudinally) into the soil volume.

Evacuation pipes may be identical to the injection pipes, but a fluid is evacuated, i.e., the fluid is driven and directed up from the soil volume (or ground water) to the ground surface in the evacuation pipes.

In this context, fluid can be a liquid such as, for example, water, or a gas such as, for example, water vapor and/or another gas.

The method of combating invasive or other unwanted plants described herein can be performed manually or automatically or partially controlled via a control system.

### Figure Legend

1. Ground surface
2. Soil volume
3. Injection pipe
4. Evacuation pipe
5. Cloth
6. Control area/treatment area
7. Sensor for temperature measurement(s)
8. Sensor for pressure measurement(s)
9. Sensor for flow measurement(s)
10. Flow regulator
11. Coupling unit, hose
12. Heating device
13. Evacuation pump

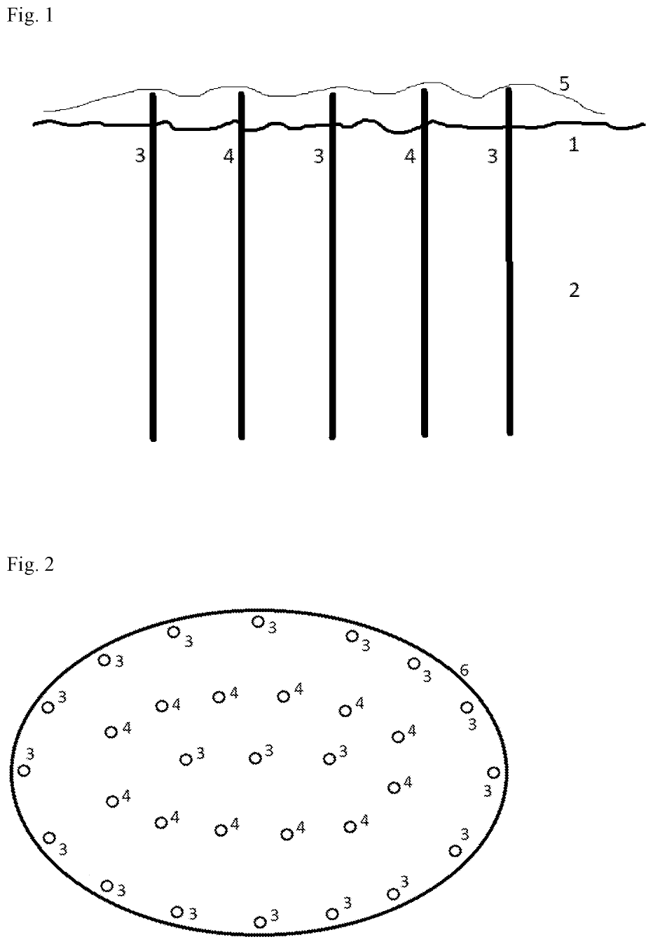

FIG. 1 shows a cross section of an example of how pipes 3, 4 are arranged from the ground surface 1 down into the soil volume 2 in an area to be treated, i.e., where invasive and/or unwanted plants are to be controlled by the present method.

Arrangement of the pipes 3, 4 is preferably done by drilling them into the soil volume 2. Other methods that can be used are e.g., to push, strike or vibrate down the pipes 3, 4 depending on the nature of the soil 2. Through pipe(s) 3 (injection pipe), heated fluid is led down to the groundwater to heat the environment, i.e., the soil volume 2 to eradicate plants to be controlled. The temperature should not be less than 40° C. in the soil volume 2, a very long treatment time would be required having a temperature below 40° C. which would be very costly. If the minimum temperature in the entire soil volume 2 is to be 40° C., it means that the fluid must have a significantly higher temperature when it is led into the pipe 3.

Heated fluid passed through the at least one pipe 3 is, for example, water, water vapor and/or other gas, or liquid-mixed steam. Normally, superheated water vapor is used as fluid. The water vapor is applied through pipe 3 into the soil volume 2 so that the area to be treated is heated to the desired temperature. The advantage of using water vapor is that the water vapor carries a lot of energy by condensing it when it meets cooler soil. Steam also has a much better penetration ability in soil than liquid. If hot air is used, some of the energy will be used to evaporate water in the soil volume 2, which means that some of the energy will not be used for heating the soil volume 2. Hot air contains a smaller amount of energy per liter, which means that a larger amount must be used for the same temperature increase. The present method therefore relates to an embodiment where water vapor is the main energy carrier, i.e., over 50%, which is about 10% by weight when mixed with boiling water or air at 300° C.

How deep into the soil 2 the pipes 3, 4 are arranged (longitudinally in relation to the ground surface 1) is determined by the ground conditions, groundwater level, which plant is to be controlled and the expected depth of the roots. The groundwater level is measured in the pipes 3, 4 as soon as the level is stabilized during the time that more pipes 3, 4 are prepared and arranged. This is done in order to be able to adjust the depth of subsequent pipes 3, 4 as most current plant species do not have root systems below the groundwater level.

In order to have a controlled spread of fluid or steam and to be able to measure the result of the treatment, one or more pipes 4 (evacuation pipes) with negative pressure are also arranged. In the one or more evacuation pipes 4, fluid, water, water vapor, liquid-mixed steam and/or gas are sucked up and pumped up from the soil volume 2. This means that the flow of fluid, steam and heat can to some extent be controlled and thereby improve the distribution of heat in soil volume 2.

The temperature of the evacuated fluid, liquid and/or gas is measured, and the treatment can be stopped when the desired safety margin to the desired final temperature is reached. The final temperature is in a range of 40-150° C., preferably at least 55° C. A temperature range of 55-70° C. is a good guideline, however, the heating cost increases and maintaining it at the higher temperatures. If there is a need to also ensure that seeds on the ground surface 1 die, a final temperature above 70° C. is selected. Separate measurement of the temperature at the ground surface can then also be performed.

The fluid, for example the water vapor, is applied with such an overpressure in the injection pipes 3 that even the water present in the soil volume 2 is to some extent pushed away and can be sucked up by the evacuation pipes 4. When water is replaced with steam the soil volume 2 decreases and the heating become both more energy efficient and the result safer.

The ground surface 1 can advantageously be covered with a cloth 5 to reduce heat losses. The cloth 5 also helps to distribute the steam over the ground surface 1 and thus the heat is also spread from above. The risk that parts of the soil volume 2 do not reach the desired temperature is minimized with the help of the cloth 5. The cloth 5 also contributes to the ground surface 1 being able to reach a slightly higher temperature which in some cases is needed to combat unwanted seeds. Preferably, a cloth 5 which is gas-tight or close to gas-tight is selected, so that steam is retained in the soil volume 2 and the gases immediately above. The cloth 5 can consist of several more or less joined parts if the treatment area 6 is large. A widespread load can be applied to the cloth 5 at the treatment area 6 the entire circumference to help maintain the steam and thereby reduce the energy losses. Point loads or spread loads can also be applied to cloth 5 within the treatment area 6 to reduce the amount of air and thus obtain more concentrated steam. In cold weather, it is advantageous to also supplement with a thermally insulating cloth on top of cloth 5 to reduce heat losses.

If necessary, the function of individual or all pipes 3, 4 can be switched so that evacuation pipes 4 become injection pipes 3 and vice versa. The pipes can be identical or different. Switching the flow direction from injection to evacuation and vice versa can also be done even during ongoing treatment.

FIG. 2 shows an example of how the pipes 3, 4 can be arranged in an area to be treated. The illustration is from above. The pipes 3, 4 are preferably arranged so that every other pipe is an injection pipe 3, and every other pipe is an evacuation pipe 4. The injection pipes 3 are preferably arranged at the outer edge so that the treatment area is encircled, optionally also injection pipe 3 is arranged towards the center of the treatment area 6 which is determined by size of the area 6, it is important that there are enough number of injection pipes 3 so that the temperature can be distributed and obtained in the entire soil volume 2 to be treated. In this way you can obtain the desired temperature in the whole area.

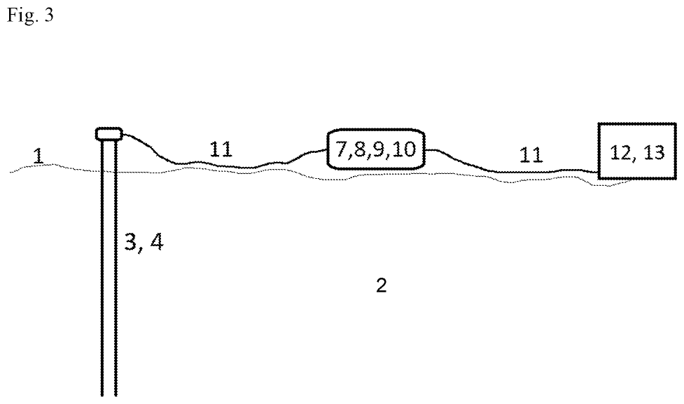

FIG. 3 Shows an example of the system, i.e., a pipe connected to equipment for performing injection/evacuation.

A pipe 3, 4 is arranged through the ground surface 1 down (longitudinally in relation to the ground surface 1) into the soil volume 2. On the pipe 3, 4 above the ground level 1 a coupling unit 11 is arranged, in this example it is a hose. A fluid is injected into pipe 3 and evacuated from pipe 4 via the hose. The hose is in turn connected via one or more sensors 7, 8, 9, flow regulator 10, heating unit 12 and evacuation pump 13.

The sensors may be one or more temperature sensors 7 which measure the temperature of injected and/or evacuated fluid, and/or one or more sensors 8 for measuring the pressure of injected and/or evacuated fluid, and/or one or more sensors 9 for measuring the flow of injected and/or evacuated fluid.

An embodiment may also include one or more regulators 10 to control the flow of injected and/or evacuated fluid. Since pressure and flow are physically connected, both are affected at the same time, but are only referred to here as flow regulation.

Sensors 7, 8, 9 and flow regulators 10 can be arranged directly at the pipes 3, 4 or at the heating device 12 or evacuation pump 13 as well as anywhere on the hose 11 as illustrated in FIG. 3. Preferably, sensors 7, 8, 9 are arranged closer to the pipes 3, 4 and flow regulators 10 are arranged closer to the heating device 12 and evacuation pump 13.

The fluid must have a high temperature, which is provided by means of one or more heating units 12, such as preferably one or more steam generators. The temperature of the fluid which is to enter the at least one injection pipe 3 can advantageously be 200-300° C. since the temperature drops quite quickly when the fluid has entered the pipe 3 to heat the surrounding soil volume 2.

One or more sensors 7 for temperature monitoring can be arranged from each evacuation pipe 4 to monitor the process. If necessary, it is also supplemented with one or more sensors for pressure and/or flow monitoring 8, 9. Similarly, sensors for temperature pressure and/or flow 7, 8, 9 can also be arranged on one or more of the injection pipes 3. Individual measurement for each pipe 3, 4 ensures that the whole treated volume reaches a desired final temperature.

An excessively high flow at low pressure to one of the injection pipes 3 relative to the other injection pipes 3 indicates that the fluid, for example the water vapor, forms unwanted channels so that the heat is not evenly distributed in the soil volume 2. This can be remedied automatically or manually by lowering the flow with a flow regulator 10 to the affected injection pipes 3. Similarly, the amount of evacuated fluid/liquid/gas can be adjusted when the comparison between pressure and flow indicates duct formation and/or when the temperature approaches the target temperature.

In summary, an environmentally friendly, fast, and safe method is provided to control invasive and unwanted plants in a soil volume which, after treatment, is fully usable to grow new desired plants or crops in.

1. A method for controlling invasive plants or unwanted plants in a soil volume, the method comprising the steps of:
arranging one or more pipes into the soil volume to be treated, and providing a tempered fluid into at least one pipe of the one or more pipes to press fluid into the soil volume, the temperature of the tempered fluid being at least 40° C., and
wherein the one or more pipes are arranged from the ground surface down into the soil volume.

2. The method for controlling invasive plants according to claim 1, wherein said fluid is water vapor.

3. The method for controlling invasive plants according to claim 1, wherein a final temperature in the entire treated soil volume exceeds 55° C.

4. The method for controlling invasive plants according to claim 3, wherein the final temperature is maintained over a period of 30 minutes to 20 days.

5. The method for controlling invasive plants according to claim 1, wherein the one or more pipes are identical or different from each other, and adapted to switch function between injection and evacuation of fluid during the time when the soil volume is treated.

6. The method for controlling invasive plants according to claim 1, wherein an amount of fluid provided into at least one of the pipes is measured and/or an amount of evacuated fluid from at least one of the pipes is measured.

7. The method for controlling invasive plants according to claim 1, wherein a pressure of fluid provided into at least one of the pipes is measured and/or a pressure of evacuated fluid from at least one of the pipes is measured.

8. The method for controlling invasive plants according to claim 1, wherein measurement of at least one of pressure and/or amount of fluid is measured in the fluid at least one of before injection into the pipes or after evacuation from the pipes.

9. The method for controlling invasive plants according to claim 1, wherein sterilization of the ground surface is carried out before the arranging, providing, and measuring steps.

10. A kit comprising components for controlling invasive plants and/or other unwanted plants in a soil volume by the method according to claim 1, the kit comprising:
one or more pipes,
one or more heating units,
one or more evacuation pumps,
one or more cloths,
one or more sensors,
one or more flow regulators, and
one or more coupling units.

11. The kit according to claim 10, wherein:
one or more sensors are adapted to measure temperature,
one or more sensors are adapted to measure pressure,
one or more sensors are adapted to measure flow, and
one or more regulators are adapted to control pressure and/or flow.

12. The method for controlling invasive plants according to claim 1, wherein the method further comprises the step of evacuating fluid from the soil volume via at least one pipe of the one or more pipes.

13. The method for controlling invasive plants according to claim 1, further comprising covering the treatment area with an insulating cloth.

14. The method for controlling invasive plants according to claim 3, wherein the final temperature is maintained over a period of one hour to 10 days.

15. The kit according to claim 10, further comprising an instruction manual describing the method and an arrangement of the components.

16. The kit according to claim 10, further comprising a data processing component that controls the kit to conduct the arranging, providing, and measuring steps.

17. The method for controlling invasive plants according to claim 1, further comprising measuring a temperature of fluid evacuated from at least one of the pipes.

18. The method for controlling invasive plants according to claim 17, further comprising determining that the temperature exceeds 40° C.
